(19) United States
(12) Patent Application Publication
(10) Pub. No.: US 2026/0171763 A1
(43) Pub. Date: Jun. 18, 2026

(54) APPLIANCE DISCONNECT

(71) Applicant: San Marino Industries LLC, Raleigh, NC (US)

(72) Inventors: Gabriel Frittelli, Four Oaks, MI (US); Michael Frittelli, Frederic, NC (US)

(73) Assignee: San Marino Industries LLC, Raleigh, NC (US)

(21) Appl. No.: 19/417,749

(22) Filed: Dec. 12, 2025

Related U.S. Application Data
(60) Provisional application No. 63/733,192, filed on Dec. 12, 2024.

(51) Int. Cl. H02B 1/46

(52) U.S. Cl. CPC H02B 1/46

(57) ABSTRACT

An appliance disconnect includes a case having a backwall, a first pair of sidewalls, a second pair of sidewalls, and a door. The case at least partially defines a cavity and the backwall extends in a first plane. An electrical assembly is located within the cavity and includes an electrical housing at least partially defining a handle recess, a first pair of connector recesses, and a second pair of connector recesses, a first pair of connectors located in corresponding recesses of the first pair of connector recesses, and a second pair of connectors located in corresponding recesses of the second pair of connector recesses. The electrical assembly also includes a pullout handle having a first bus bar and a second bus bar.

### CROSS-REFERENCE TO RELATED APPLICATIONS

The present application claims the benefit of priority to U.S. Provisional Patent Application No. 63/733,192 filed on Dec. 12, 2024, which is hereby incorporated by reference in its entirety.

### INTRODUCTION

The present disclosure relates to electrical disconnect devices (“appliance disconnects”) for an appliance or an electric vehicle (EV) charging unit, with the appliance disconnect generally located between a load center and the appliance or EV charging unit.

### SUMMARY

An appliance disconnect is disclosed herein. The appliance disconnect includes a three-wire wiring set with (2) positives, a neutral, and a ground wire, a low-profile case that contains or houses the positives, neutral, and ground wires, and a pullout handle for shutoff. In one or more embodiments, the pullout handle is connected to the positive wires and configured to switch the appliance disconnect between an OFF/non-conducting state and an ON/conducting state (“off to on”), and between the ON state and the OFF state (“on to off”). The appliance disconnect can be used with a single-phase, three-wire, 240 VAC (Volts Alternating Current) power connection and/or a single-phase, four-wire, 240 VAC power connection. This may include several wires of different types and conductivities.

The appliance disconnect may also include one or more separated neutral and grounding bars, and/or an easy-to-remove high-strength protective shield that facilitates wiring and mounting. The appliance disconnect may also include a similarly easy-to-remove front cover and front door. In some constructions, the appliance disconnect is characterized by an absence of screws or fasteners to remove.

The appliance disconnect may also include the above-noted low-profile case, which may be optionally embodied as a NEMA 3R outdoor metallic enclosure having a low-profile and/or a compact design. Such features allow for tight spaces and shallow installations, as well as single-phase or three-phase, three-wire, 240 VAC power connections, and three-phase, three-wire, 240 VAC.

The appliance disconnect in various constructions may also include separated neutral and grounding bars, 1-inch (1″) knockouts on the back of the case, ¾″ knockouts on the bottom and/or side of the case, copper and aluminum rated line and load lugs that are easily accessible, and ample wiring space for mounting of the appliance disconnect. Representative mounting approaches include, but are not limited to, single-keyhole, two-point, or three-point mounting; service-entrance-rated, unfused switches or other unfused devices; and/or a horsepower (HP) rating of 60 amperes (A) or 19.3 HP. The appliance disconnect may include a padlockable door for safety and to reduce tampering. The case may be constructed as a metallic enclosure that is accessible solely from the bottom of the case (“bottom entry and exit only”), and/or may include factory-installed tamper-resistant/weather-resistant receptacles.

Disclosed herein is an appliance disconnect. The appliance disconnect includes a case having a backwall, a first pair of sidewalls, a second pair of sidewalls, and a door, wherein the case at least partially defines a cavity, and the backwall extends in a first plane. An electrical assembly is located within the cavity. The electrical assembly includes an electrical housing at least partially defining a handle recess, a first pair of connector recesses, and a second pair of connector recesses, a first pair of connectors located in corresponding recesses of the first pair of connector recesses, and a second pair of connectors located in corresponding recesses of the second pair of connector recesses. The electrical assembly also includes a pullout handle having a first bus bar and a second bus bar. The first bus bar is configured to form an electrical connection between the first pair of connectors, and the second bus bar is configured to form a second electrical connection between the second pair of connectors when in a first orientation and disconnect the first pair of connectors and the second pair of connectors when in a second orientation. The pullout handle is configured to move within the handle recess in a direction parallel to the first plane of the backwall.

In one aspect of the disclosure, the pullout handle is configured to switch the appliance disconnect from a non-conducting OFF state to a conducting/ON state, and vice versa.

In one aspect of the disclosure, the disconnect includes a ground-phase assembly located within the cavity, configured to connect ground wires within the cavity electrically.

In one aspect of the disclosure, the disconnect assembly includes a neutral-phase assembly located within the cavity, comprising a housing and a pair of neutral-phase connectors.

In one aspect of the disclosure, each of the pair of neutral-phase connectors includes a screw in threaded engagement with a connector housing and the screw is configured to move in a direction relative to the connector housing perpendicular to the first plane of the backwall.

In one aspect of the disclosure, the disconnect assembly includes a protective shield in direct engagement with the case and the electrical assembly.

In one aspect of the disclosure, the door is characterized by an absence of screws or fasteners.

In one aspect of the disclosure, the first pair of connectors and the second pair of connectors include copper and aluminum-rated line and load lugs, and the case includes one or more mounting holes, including a single keyhole or a two- or three-point mounting hole.

In one aspect of the disclosure, the housing includes a plurality of knockouts and the door includes a receptacle that accepts a locking projection on the housing.

In one aspect of the disclosure, the cavity includes a portion for accepting the pullout handle when moving into or out of the handle recess on the electrical housing.

In one aspect of the disclosure, the first pair of connectors includes a screw in threaded engagement with a connector housing and the screw is configured to move in a direction relative to the connector housing perpendicular to the first plane of the backwall.

In one aspect of the disclosure, the connector housing for each of the first pair of connectors includes a tab that extends in a direction generally parallel to the backwall of the case for engaging one of the first bus bar or the second bus bar.

In one aspect of the disclosure, the second pair of connectors includes a screw in threaded engagement with a connector housing and the screw is configured to move in a direction relative to the connector housing perpendicular to the first plane of the backwall.

In one aspect of the disclosure, the connector housing for each of the second pair of connectors includes a tab that extends in a direction generally parallel to the backwall of the case for engaging one of the first bus bar or the second bus bar.

In one aspect of the disclosure, a wall extends through the handle recess to separate a first portion from a second portion.

In one aspect of the disclosure, the pullout handle is configured to remain a pullout handle portion of the cavity when moving into and out of the handle recess on the electrical housing.

In one aspect of the disclosure, the handle recess faces towards one of the first pair of sidewalls or the second pair of sidewalls.

Disclosed herein is a method of operating an appliance disconnect. The method includes moving a pullout handle in one of the first or second directions relative to an electrical assembly during an applicant disconnect. The appliance disconnect comprises a case having a backwall, a first pair of sidewalls, a second pair of sidewalls, and a door, wherein the case at least partially defines a cavity, and the backwall extends in a first plane. An electrical assembly is located within the cavity. The electrical assembly includes an electrical housing at least partially defining a handle recess, a first pair of connector recesses, and a second pair of connector recesses, a first pair of connectors located in corresponding recesses of the first pair of connector recesses, and a second pair of connectors located in corresponding recesses of the second pair of connector recesses. The electrical assembly also includes a pullout handle having a first bus bar and a second bus bar. The first bus bar is configured to form an electrical connection between the first pair of connectors, and the second bus bar is configured to form a second electrical connection between the second pair of connectors when in a first orientation and disconnect the first pair of connectors and the second pair of connectors when in a second orientation. The pullout handle is configured to move within the handle recess in a direction parallel to the first plane of the backwall. The method also includes moving the pullout handle in the other of the first direction or the second direction relative to the electrical assembly.

In one aspect of the disclosure, the pullout handle remains in a pullout handle portion of the cavity when moving in the first direction or the second direction.

In one aspect of the disclosure, each of the pair of neutral-phase connectors includes a screw in threaded engagement with a connector housing and the threaded screw is configured to move in a direction relative to the connector housing perpendicular to the first plane of the backwall. The first pair of connectors includes a screw-in threaded engagement with a connector housing, and the threaded screw is configured to move in a direction relative to the connector housing perpendicular to the first plane of the backwall. The second pair of connectors includes a screw-in threaded engagement with a connector housing, and the threaded screw is configured to move in a direction relative to the connector housing perpendicular to the first plane of the backwall.

The above features and advantages, and other features and advantages of the present disclosure, are readily apparent from the following detailed description of the best modes for carrying out the disclosure when taken in connection with the accompanying drawings.

### BRIEF DESCRIPTION OF THE DRAWINGS

FIG. 1 is a schematic diagram of an isometric view of an appliance disconnect with a door closed.

FIG. 2 is a schematic diagram of an isometric view of an appliance disconnect with a door open.

FIG. 3 is a schematic diagram of a front elevation view of an appliance disconnect with a door open, with a section line for FIG. 8.

FIG. 4 is a schematic diagram of a back elevation view of an appliance disconnect.

FIG. 5 is a schematic diagram of a side elevation view of an appliance disconnect with a door open.

FIG. 6 is a schematic diagram of a top elevation view of an appliance disconnect with the door open.

FIG. 7 is a schematic diagram of a bottom-side elevation view of an appliance disconnect with the door open.

FIG. 8 is a schematic diagram of an isometric view of an appliance disconnect with the door open, taken substantially on section line 8-8 of FIG. 3.

FIG. 9 is a schematic diagram of an isometric view of an appliance disconnect with the door open and a shield removed to view interior portions thereof.

### DETAILED DESCRIPTION

Referring to the drawings, like reference numbers refer to similar components, wherever possible. All figure descriptions may simultaneously refer to all other figures.

An electrical disconnect for an appliance, electric vehicle (EV) charging unit, or other electrical system is referred to herein as an appliance disconnect 10 for illustrative consistency. The appliance disconnect 10 may be located generally between a load center (e.g., a distribution panel, not shown) and an appliance or an EV charging unit (neither of which is shown). The appliance disconnect 10 provides an installer or repair personnel with a visible disconnecting means when performing maintenance. The appliance disconnect 10 may also disconnect pullouts or air conditioning switches, likewise omitted from the figures for illustrative simplicity. The appliance disconnect 10 may also be referred to as a housing or house.

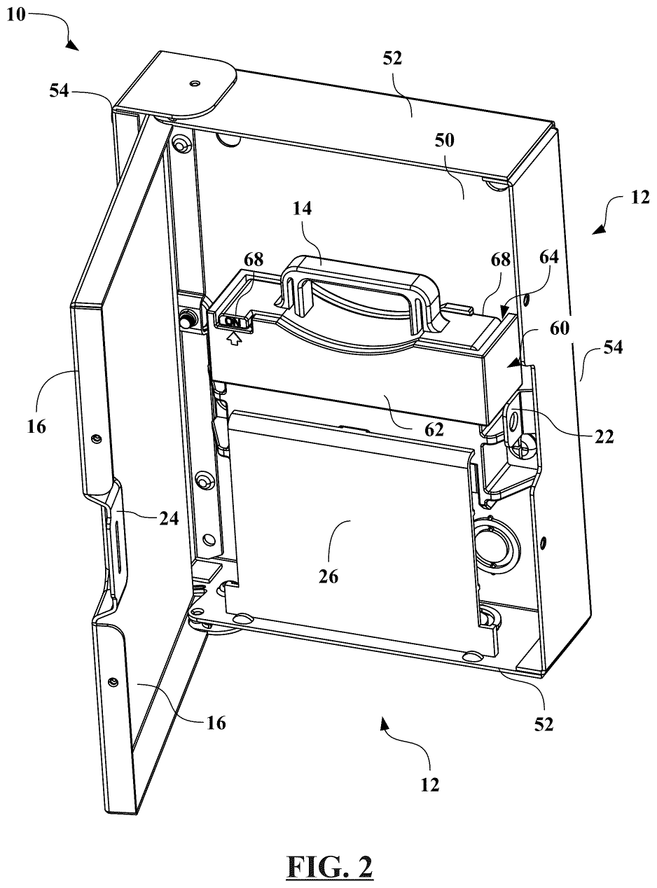

The appliance disconnect 10 includes a low-profile case 12, a pullout handle 14, as shown in FIG. 2, and a front door 16. Note that the front door 16 may be considered part of the case 12, with the pullout handle 14 being connected to the case 12 as illustrated in FIGS. 2, 3, 8, and 9. The case 12 and the front door 16 can be formed from a metallic sheet that is bent or stamped to create the final molded shape.

In the illustrated example, the case 12 includes a backwall 50, a first pair of opposing walls 52, and a second pair of opposing walls 54. Depending on the orientation of the case 12, the first pair of walls 52 could be sidewalls and the second pair of walls 54 could be the top and bottom walls, or vice versa. The backwall 50 extends in a first plane, with the first and second pairs of walls 52 and 54 extending in planes that are perpendicular to the first plane of the backwall 50. When the front door 16 is in a closed position, it extends in a plane that is generally perpendicular to the first plane of the backwall 50.

The case 12 and the front door 16 at least partially define a cavity 48 for accepting an electrical assembly 60. In the illustrated example, the electrical assembly 60 includes an electrical housing 62 defining a handle recess 64 and electrical connector recesses 66. The handle recess 64 is configured to accept the pullout handle in a first orientation, completing an electrical circuit, and a second orientation, breaking or disconnecting an electrical connection. The pullout handle 14 also includes indicator 68, indicating the rotational position of the pullout handle 14 to provide a visual indication of the status of the electrical connection to the load. The electrical housing 62 can be formed from a non-electrically conductive material, such as a plastic or polymer.

As shown in FIGS. 2-3 and 8-9, the cavity 48 includes a pullout region 56 located between the electrical housing 62 and the pair of walls 52. One feature of the pullout region 56 is to allow the pullout handle 14 to be removed from the electrical assembly 60 within the case 12. For example, the pullout handle 14 can be removed from the electrical housing 62 by moving it in a direction generally parallel to the first plane of the backwall 50. This enables the depth of case 12, as defined by the heights of the first and second pairs of walls 52 and 54, to be reduced, allowing case 12 to fit in locations with reduced space. In particular, this allows the case 12 to be used in cabinets behind drawers or in walls between studs.

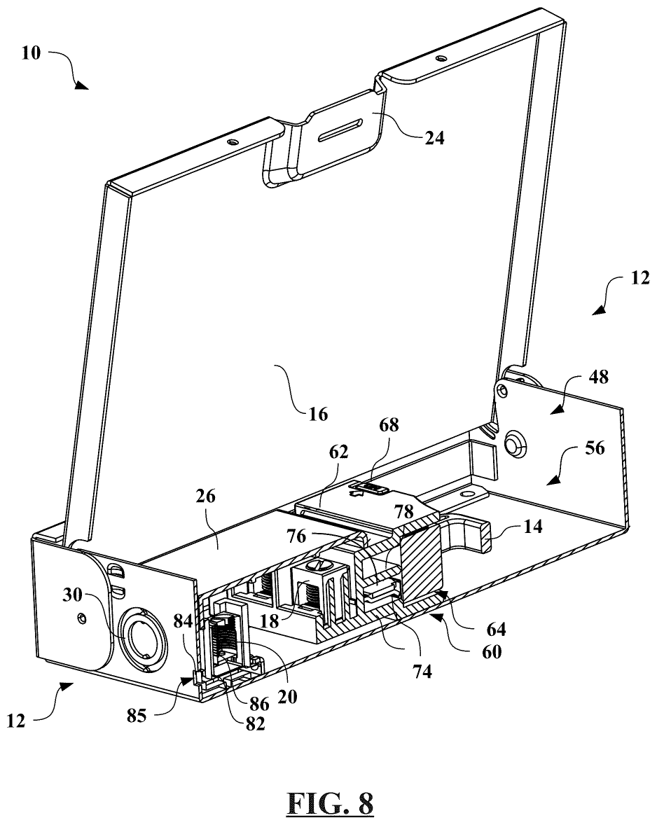

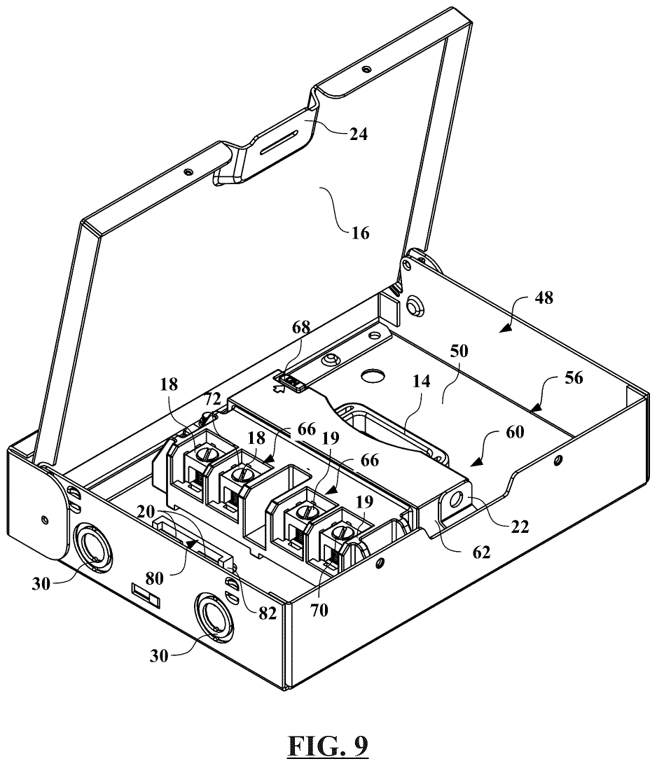

As shown in FIG. 9, the electrical connector recesses 66 accept a first pair of electrical connectors 18 and a second pair of electrical connectors 19. In the illustrated example, the first and second pairs of electrical connectors 18 and 19 are screw-type fasteners. In one example, each of the first pair of electrical connectors 18 and the second pair of electrical connectors 19 includes a positive in terminal and a positive out terminal. The screw-type fasteners include a screw 70 that rotatably engages a threaded portion on a connector housing 72. When rotated, the threaded screws 70 move in a longitudinal direction that is perpendicular to the first plane of the backwall 50 of the case 12. Each of the connector housings 72 includes a tab 74 (FIG. 8) that is configured to engage a corresponding bus bar 76 (FIG. 8) on the pullout handle 14. Each of the tabs 74 extends in a direction generally parallel to the first plane of the backwall 50.

When the pullout handle 14 is in a first orientation or rotational position, a first electrical connection is formed between each of the first pair of electrical connectors 18 and a second electrical connection is formed between each of the second pair of electrical connectors 19. This corresponds to the indicator “ON” shown in FIGS. 8 and 9. Conversely, when the pullout handle 14 is in a second orientation or rotational position, the first and second electrical connections are broken or disconnected. This corresponds to a separate indicator “OFF” (not shown) when the pullout handle 14 is in the second position. Furthermore, the electrical housing 62 includes a dividing wall 78 that creates a physical separation between the tabs 74 and the bus 76 when in the “OFF” or second orientation.

The first and second pairs of electrical connectors 18 and 19 may be constructed as rated copper and aluminum rated line and load lugs designed to handle both copper and aluminum wire in the same connector. Note that this may be referred to collectively as the electrical connector.

As shown in FIGS. 8 and 9, a neutral-phase assembly 80 includes a neutral-phase housing 82 having a pair of terminal recesses for accepting a pair of neutral-phase connectors 20. The neutral-phase housing 82 is separately attached to the case 12 from the electrical assembly 60. In particular, the neutral-phase housing 82 includes a projection 84 that engages an opening 85 defined by the case 12 to removably attach the neutral-phase housing 82 to the case 12, depending on the application for the appliance disconnect 10. The neutral-phase connectors 20 include screw-type fasteners, including a threaded screw 86 that rotatably engages the neutral-phase housing 82. When rotated, the threaded screws 86 move in a longitudinal direction that is perpendicular to the first plane of the backwall 50 of the case 12. Also, the neutral-phase connectors 20 are electrically connected to one another.

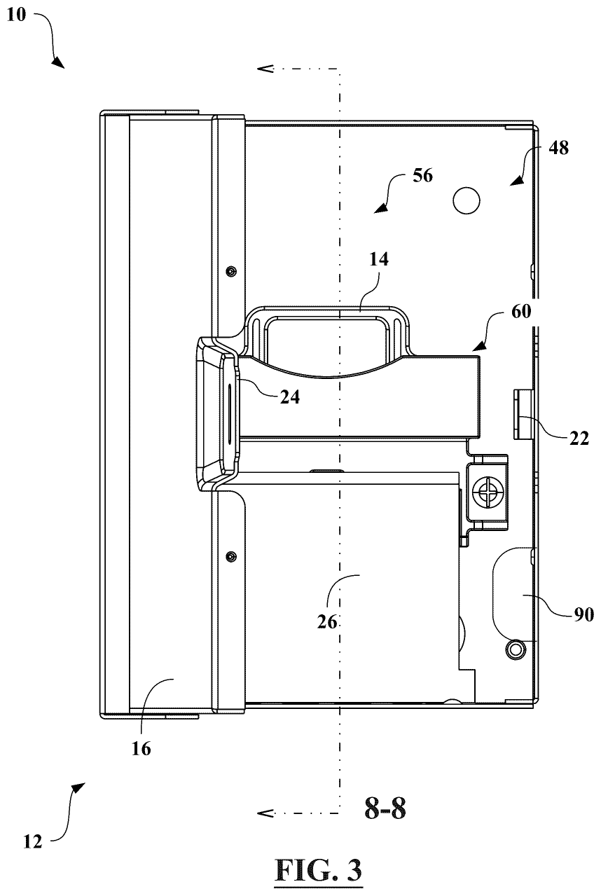

Note that there may be another ground-phase assembly having ground-phase connectors 90 (FIG. 3) for connecting ground wires to the case 12. Without limitation, the electrical connectors 18, 19, 20, and 90 may be collectively referred to as the connectors. These may also be referred to as grounding bars.

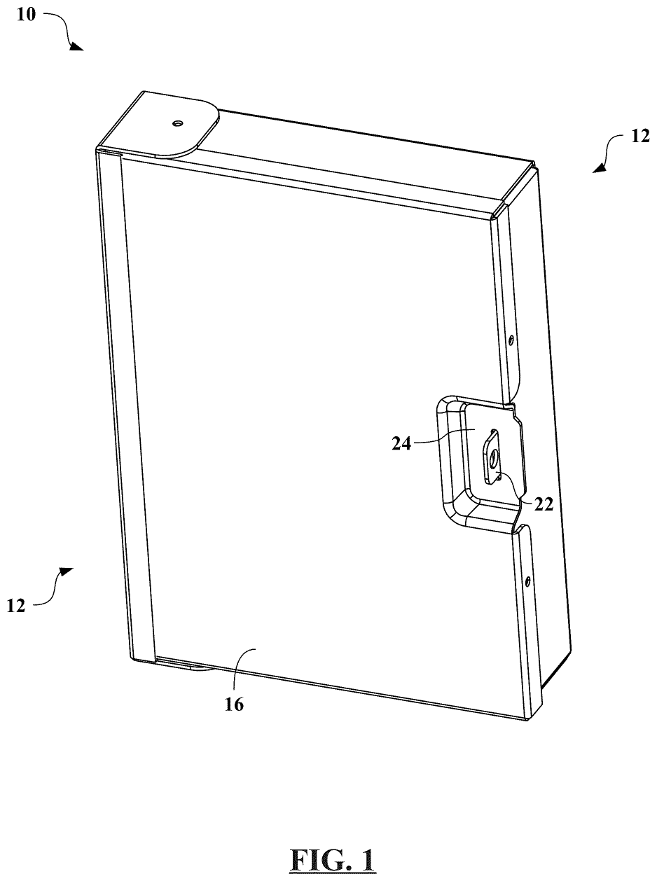

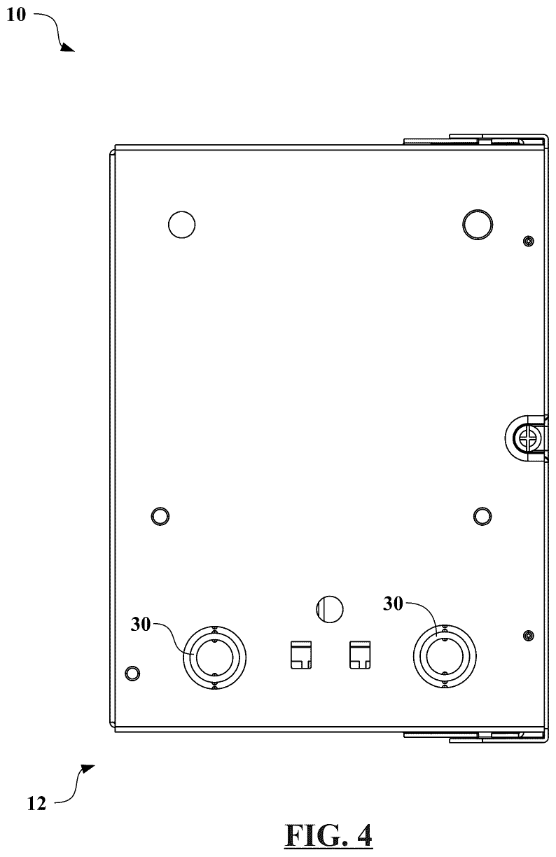

The appliance disconnect 10 of FIG. 1 further includes a latch 22, a latch holder 24, and a shield plate 26 (see FIG. 2). To secure the appliance disconnect 10, therefore, a padlock (not shown) may be inserted through the latch 22 and the latch holder 24. Additionally, as best shown in FIGS. 4, 7, 8, and 9, the appliance disconnect 10 may include or define several knockouts 30 or punch-out holes. The shield plate 26, for its part, may be an easy-to-remove, high-strength protective shield that facilitates wiring and mounting, with the front door 16 being similarly easy to remove. As used herein, “easy-to-remove” may entail the absence of screws or fasteners, such that an absence of such fasteners characterizes the appliance disconnect 10. The “no screws” structure described herein thus makes it easier to remove the shield plate 26 and front door 16, such that an able-bodied person may remove these components without special tools or equipment. The absence of screws or fasteners thus eliminates the need for special equipment/tools.

The pullout handle 14 may also be referred to as an unfused pullout handle 14. Non-fused, or unfused, disconnect switches are a perfect choice for residential and commercial environments where the current won't go beyond the switch's capacity. This type of switch is the ideal choice for residential electrical projects. As appreciated in the art, unfused devices may lack an integral fuse, with unfused devices often used where an electric current does not exceed the current rating of the device. As opposed to fused disconnect switches, which may be essential for commercial and industrial applications because they provide quick shut-off in an emergency.

Constructing the pullout handle 14 as an unfused pullout unit provides an additional level of protection for an appliance/EV charger. Unfused devices are of a pullout design, where the user physically removes or “pulls out” a tab to break the electrical connection—note that this may break the tab, such that it may not be usable again. The pullout handle 14 of FIGS. 2, 3, 8, and 9 may be conveniently stored within the case 12 in the OFF position, helping to prevent the pullout handle 14 from being misplaced. The shield plate 26 of FIG. 2 cannot generally be removed until the pullout handle 14 is removed, thereby disconnecting the power.

The pullout handle 14 is generally connected to at least the first and second pairs of connectors 18 and 19 of FIGS. 8 and 9, such that disconnecting power from the respective connectors generally breaks all of the circuits. The low-profile case 12 switch devices provide personnel with a visible ON-OFF disconnecting indicator 68. For example, the pullout handle 14 may switch the appliance disconnect 10 between an ON/conducting state and an OFF/non-conducting state, and vice versa.

The low-profile case 12 and its optional compact design allow for tight spaces and shallow installations, facilitating the installation of the appliance disconnected 10 in tight/space-restricted areas. The optional compact design may be defined by between, and without limitation, about 170 centimeters (cm)-about 200 cm (or about 65″-80″) by about 180 cm-about 220 cm (or about 70″-about 90″) by about 30 cm-about 45 cm (or 10″-about 19″).

Note that the low-profile case 12 may be formed from, for example, and without limitation, a NEMA 3R outdoor metallic enclosure. National Electrical Manufacturers Association (NEMA) defines a product, process, or procedure with reference to one or more of the following, without limitation: nomenclature, composition, construction, dimensions, tolerances, safety, operating characteristics, performance, ratings, and/or testing for the particular service for which it is designed.

Other metallic enclosures may be used within the scope of the disclosure, for instance, plastic, composite, or any other structures that will be recognizable by those having ordinary skill in the art. The ON/OFF state of the appliance disconnect 10 may be controlled by actuation of the pullout handle 14.

In an alternative construction, not illustrated herein and without limitation, the low-profile case 12 may be constructed as a rugged case. The rugged case may include a disconnect switch that looks like a circuit breaker but operates like an ordinary household light switch. This plug-in case switch eliminates the need for pullout handles such as the pullout handle 14 described above, and there is, generally, no need for replacement pullout handles due to loss and/or theft.

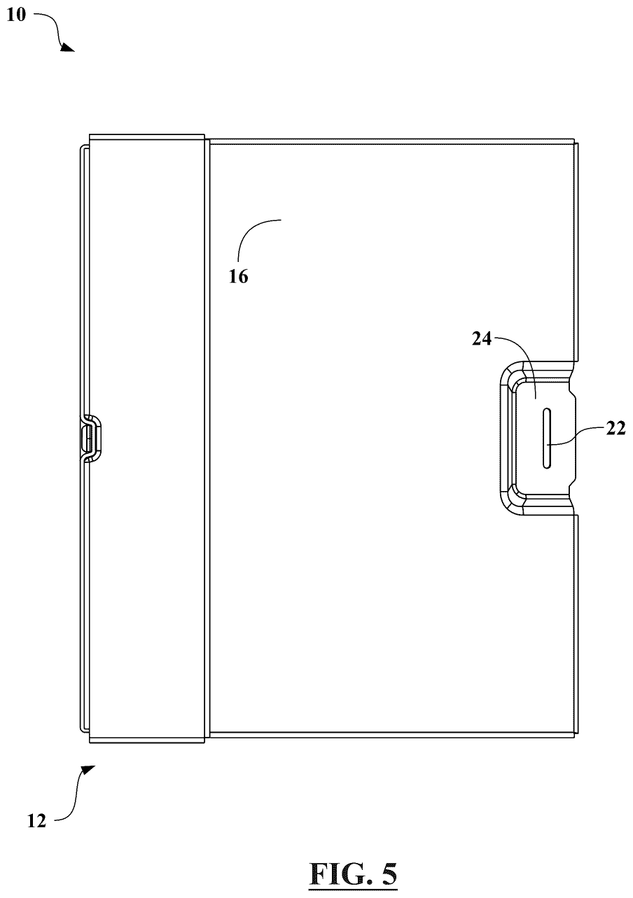

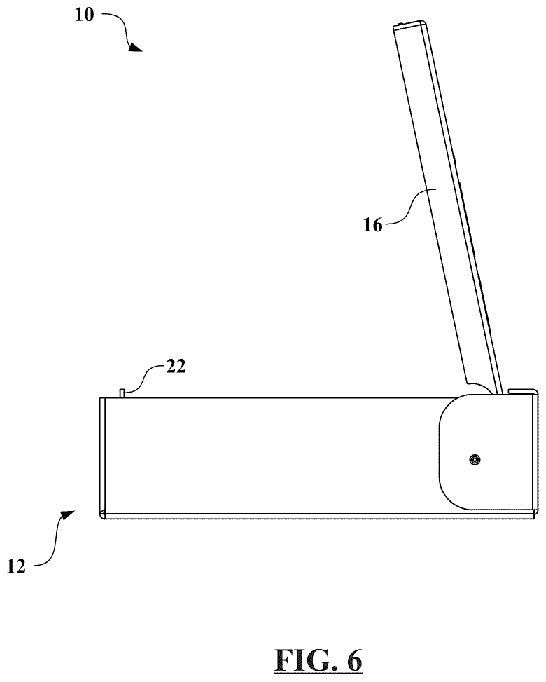

The appliance disconnect 10 described above and shown in FIGS. 1-9 may be used for residential and light commercial applications, electric vehicle charging units, appliances, and heat and air conditioning units—none of which are shown in the figures for illustrative simplicity. The appliance disconnect 10 may be installed indoors or outdoors, within sight of the appliance, electric vehicle charging unit, and/or air conditioner condensing unit with which the appliance disconnect 10 is used. The appliance disconnect 10 may also be used, for example, and without limitation, with heat pumps, swimming pools, spas, whirlpools, and/or pump houses, and may meet the 2008 NEC Article 422.31(B) requirements for servicing electric water heaters. The case 12 may be galvanized steel or other materials, without limitation, and may be installed in various locations.

The low-profile case 12 may include, without limitation, single-phase, three-wire, 240 VAC (Volts Alternating Current) and three-phase, three-wire, 240 VAC. The low-profile case 12, without limitation, may allow for tight spaces and shallow installation applications, and may separate neutral and grounding bars. Such neutral and grounding bars—which may be more accurately referred to as bonds—are used to prevent parallel current paths. Ensuring that the ground wire and the neutral wire are not connected at any point within a panel, except for the single designated bonding point, allows the wires to function independently while maintaining proper safety standards.

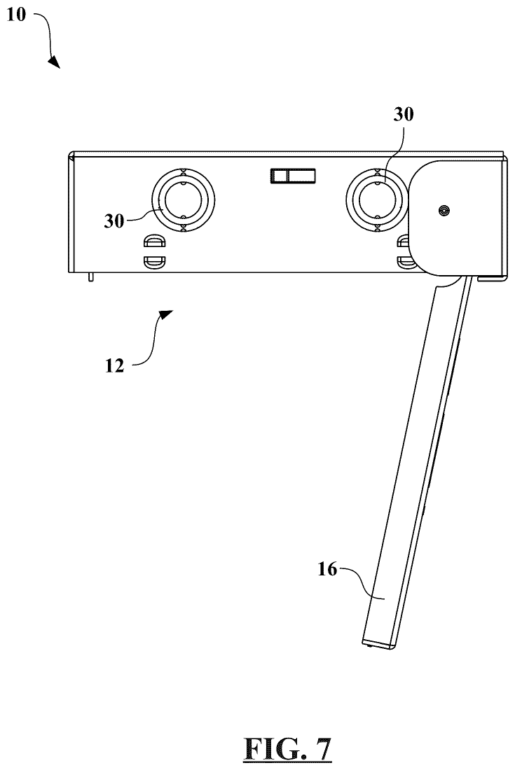

The appliance disconnect 10 described herein further may include, without limitation, 1″ knockouts 30 located on the back of the appliance disconnect 10 (FIGS. 3 and 9), 34″ knockouts 30 located on the bottom of the appliance disconnect 10 (FIG. 7), and copper and aluminum rated line and load lugs (not shown) that are easily accessible to a user upon opening the front door 16 of FIG. 1. Copper wire may be preferred over aluminum in one or more implementations because of its relatively high strength and durability over time. The locations of the above-described ¾″ and 1″ knockouts 30 on the back and bottom of the appliance disconnect 10 may also be reversed, while one or more knockouts 30 may be present on the sides of the appliance disconnect 10 in other embodiments

The low-profile case 12 may include, without limitation, ample wiring space for mounting with a stud gun, including single-keyhole, two-point, or three-point mounting. Therefore, there may be one point of contact, two points of contact, or three points of contact, or more, as would be recognized by those having ordinary skill in the art. The holes are shown as knockout holes 30 in FIGS. 3, 4, and 9, with additional or fewer knockout holes 30 possibly used in other embodiments.

As noted above, unfused devices are service entrance-rated, horsepower-rated at 60 AMP/19.3 HP, and may have a padlockable door provision, with a padlock included (not shown) for added safety and reduced tampering. Note that factory-installed tamper-resistant/weather-resistant receptacles may be attached to any side of the appliance disconnect 10 or elsewhere, as would be recognized by those having ordinary skill in the art. Tamper-resistant receptacles are receptacles for use in dwelling units in accordance with the NEC (National Electrical Code), specifically, Section 210.52, and are identified by the words “Tamper Resistant” or the letters “TR” where they will be visible after installation with a cover plate removed.

Weather-resistant receptacles are designed with nylon and corrosion-resistant metal components. When installed in an approved weather protective cover, weather-resistant receptacles offer extra durable protection from rain, snow, ice, moisture, and humidity. Note that these may be installed on any surfaces or elsewhere, as would be recognized by those having ordinary skill in the art.

The drawings and figures presented herein are diagrams, are not to scale, and are provided purely for descriptive and supportive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second,” are illustrative only and are not intended to limit the scope of the disclosure in any way. Any use of the term “or,” whether in the specification or claims, is inclusive of any specific element referenced and also includes any combination of the elements referenced, unless otherwise explicitly stated.

Features shown in one figure may be combined with, substituted for, or modified by features shown in any of the Figures. Unless stated otherwise, no features, elements, or limitations are mutually exclusive of any other features, elements, or limitations. Furthermore, no features, elements, or limitations are absolutely required for operation. Any specific configurations shown in the figures are illustrative only, and the specific configurations shown are not limiting of the claims or the description.

All numerical values of parameters (e.g., of quantities or conditions) in this specification, including the appended claims, are to be understood as being modified in all instances by the term about whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used, the term “substantially” refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the acceptable range of variance. For example, and without limitation, coverages, areas, or distances may generally be within 10% of perfection for substantial equivalence. Similarly, relative alignments, such as parallel or perpendicular, may generally be considered to be within 5%.

The detailed description and the drawings or figures are supportive and descriptive of the subject matter herein. While some of the best modes and other embodiments have been described in detail, various alternative designs, embodiments, and configurations exist.

Furthermore, any embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. An appliance disconnect, comprising:
a case including a backwall, a first pair of sidewalls, a second pair of sidewalls, and a door, wherein the case at least partially defines a cavity and the backwall extends in a first plane;
an electrical assembly located within the cavity, wherein the electrical assembly includes:
an electrical housing at least partially defining a handle recess, a first pair of connector recesses, and a second pair of connector recesses;
a first pair of connectors located in corresponding recesses of the first pair of connector recesses;
a second pair of connectors located in corresponding recesses of the second pair of connector recesses; and
a pullout handle having a first bus bar and a second bus bar, wherein the first bus bar is configured to form an electrical connection between the first pair of connectors and the second bus bar is configured to form a second electrical connection between the second pair of connectors when in a first orientation and disconnect the first pair of connectors and the second pair of connectors when in a second orientation, and the pullout handle is configured to move within the handle recess in a direction parallel to first plane of the backwall.

2. The appliance disconnect of claim 1, wherein the pullout handle is configured to switch the appliance disconnect from a non-conducting OFF state to a conducting/ON state, and vice versa.

3. The appliance disconnect of claim 1, including a ground-phase assembly located within the cavity configured to connect ground wires within the cavity electrically.

4. The appliance disconnect of claim 3, including a neutral-phase assembly located within the cavity and including a housing and a pair of neutral-phase connectors.

5. The appliance disconnect of claim 4, wherein each of the pair of neutral-phase connectors includes a screw in threaded engagement with a connector housing and the screw is configured to move in a direction relative to the connector housing perpendicular to the first plane of the backwall.

6. The appliance disconnect of claim 1, including a protective shield in direct engagement with the case and the electrical assembly.

7. The appliance disconnect of claim 1, wherein the door is characterized by an absence of screws or fasteners.

8. The appliance disconnect of claim 1, wherein the first pair of connectors and the second pair of connectors include copper and aluminum rated line and load lugs, and the case includes one or more mounting holes, including a single keyhole or a two or three-point mounting hole.

9. The appliance disconnect of claim 8, wherein the housing includes a plurality of knockouts and the door includes a receptacle that accepts a locking projection on the housing.

10. The appliance disconnect of claim 1, wherein the cavity includes a portion for accepting the pullout handle when moving into or out of the handle recess on the electrical housing.

11. The appliance disconnect of claim 1, wherein the first pair of connectors includes a screw in threaded engagement with a connector housing and the screw is configured to move in a direction relative to the connector housing perpendicular to the first plane of the backwall.

12. The appliance disconnect of claim 11, wherein the connector housing for each of the first pair of connectors includes a tab that extends in a direction generally parallel to the backwall of the case for engaging one of the first bus bar or the second bus bar.

13. The appliance disconnect of claim 1, wherein the second pair of connectors includes a screw in threaded engagement with a connector housing and the screw is configured to move in a direction relative to the connector housing perpendicular to the first plane of the backwall.

14. The appliance disconnect of claim 13, wherein the connector housing for each of the second pair of connectors includes a tab that extends in a direction generally parallel to the backwall of the case for engaging one of the first bus bar or the second bus bar.

15. The appliance disconnect of claim 1, wherein a wall extends through the handle recess to separate a first portion from a second portion.

16. The appliance disconnect of claim 1, wherein the pullout handle is configured to remain a pullout handle portion of the cavity when moving into and out of the handle recess on the electrical housing.

17. The appliance disconnect of claim 16, wherein the handle recess faces towards one of the first pair of sidewalls or the second pair of sidewalls.

18. A method of operating an appliance disconnect, the method comprising:
moving a pullout handle in one of a first direction or a second direction relative to an electrical assembly in an applicant disconnect, wherein the appliance disconnect includes:
a case including a backwall, a first pair of sidewalls, a second pair of sidewalls, and a door, wherein the case at least partially defines a cavity and the backwall extends in a first plane and the first direction and the second direction are parallel to the first plane of the backwall;
the electrical assembly located within the cavity, wherein the electrical assembly includes:
an electrical housing at least partially defining a handle recess, a first pair of connector recesses, and a second pair of connector recesses;
a first pair of connectors located in corresponding recesses of the first pair of connector recesses;
a second pair of connectors located in corresponding recesses of the second pair of connector recesses; and
the pullout handle having a first bus bar and a second bus bar, wherein the first bus bar is configured to form an electrical connection between the first pair of connectors and the second bus bar is configured to form a second electrical connection between the second pair of connectors when in a first orientation and disconnect the first pair of connectors and the second pair of connectors when in a second orientation, and the pullout handle is configured to move within the handle recess in a direction parallel to first plane of the backwall; and
moving the pullout handle in the other of the first direction or the second direction relative to the electrical assembly.

19. The method of claim 18, wherein the pullout handle remains in a pullout handle portion of the cavity when moving in the first direction or the second direction.

20. The method of claim 18, wherein
each of the pair of neutral-phase connectors includes a screw in threaded engagement with a connector housing and the threaded screw is configured to move in a direction relative to the connector housing perpendicular to the first plane of the backwall;
the first pair of connectors includes a screw in threaded engagement with a connector housing and the threaded screw is configured to move in a direction relative to the connector housing perpendicular to the first plane of the backwall; and
the second pair of connectors includes a screw in threaded engagement with a connector housing and the threaded screw is configured to move in a direction relative to the connector housing perpendicular to the first plane of the backwall.
